(19) United States
(12) Patent Application Publication
(10) Pub. No.: US 2011/0099782 A1
(43) Pub. Date: May 5, 2011

(54) METHOD FOR CONVERTING A LETTER ENVELOPE PRODUCTION MACHINE FROM SET-UP MODE INTO A NORMAL PRODUCTION MODE

(75) Inventors: Reiner Schonberger, Grossholbach (DE); Antonius Kloft, Hahn Am See (DE); Carsten Schrader, Thalhausen (DE)

(73) Assignee: WINKLER + DUENNEBIER AG, Neuwied (DE)

(21) Appl. No.: 12/995,077

(22) PCT Filed: May 14, 2009
(86) PCT No.: PCT/EP2009/003434

§ 371 Date: Nov. 29, 2010

(30) Foreign Application Priority Data
May 28, 2008 (DE) 10 2008 025 493.2

(51) Int. Cl. B23P 19/00

(52) U.S. Cl. 29/401.1

(57) ABSTRACT

A method for converting a letter envelope production machine from a set-up mode to a normal production mode includes extracting letter envelope test samples via an extraction point of the letter envelope production machine, and moving a work station in the area of the extraction point between the extraction point at which letter envelope test samples are extracted and a production position in which letter wraps are produced. The work station is in the extraction position during the set-up mode and the letter envelope test samples are extracted at the extraction point. The letter envelope production machine continues running at a base speed during the conversion so that the movement of the work station to the production position during the operation of the letter envelope production machine will occur at base speed and set-up results obtained during the prior set-up mode will be maintained.

### FIELD OF THE INVENTION

The invention at hand relates to a method for the conversion of a letter envelope production machine from a set-up mode to a normal production mode. Letter envelopes in the sense of the invention at hand are to be understood as letter wrappings or so-called shipping pouches.

### BACKGROUND

FIG. 4 shows the schematic lateral view of a letter envelope production machine that has been known per se. It comprises a multitude of individual work stations, each carrying out, within the framework of the production of the letter envelopes, specific production steps that have also been known per se. In order to assure that letter envelopes of the highest possible quality are produced, it is common to test within the framework of a so-called set-up mode of the letter envelope production machine whether or not the individual work stations carry out their respective production steps flawlessly.

In this context it has been known to extract, for quality control purposes, at such an extraction point of the letter envelope production machine letter envelope test samples on which as many letter envelope production steps as possible have been completed. In the case of the letter envelope production machine shown in FIG. 4 the extraction of the letter envelope test samples occurs in the area of the adhesive coating station 3 to apply an adhesive to the closing flaps. At this point of the machine, a large part of the letter envelope production steps have already occurred so that almost-finished letter envelopes can be extracted here. Only the production steps of applying an adhesive to the closing flaps, of drying the adhesive applied to the closing flap and of folding the closing flap over are yet to follow. If necessary, the production step of applying a dry-bond adhesive may occur whose protective strip is removed prior to a later use of the letter envelope. The aforementioned letter envelope production steps are carried out by the closing flap adhesive coating station 3, the drying station 19 as well as the closing flap folding station 20 as can be seen in FIG. 4.

For an extraction of the letter envelope test samples in the case of the letter envelope production machine according to FIG. 4, the closing flap adhesive coating station 3 can be swung around a vertical axis from its production position into an extraction position. Subsequently, a collection container to collect the letter envelope test samples is moved close to the extraction point, with the container actuating a safety switch in its intended collection position. The machine drive can be activated only when the safety switch has been actuated. For the extraction of the letter envelope test samples, the letter envelope production machine is operated at a suitable speed, and a manually operable reject deflector guides the letter envelope test samples into the collection container. They can be retrieved from the latter and subjected to a quality check. Within the framework of the latter, an imprint that may exist; the window position; the cut geometry, as well as the fold geometry and the like are checked, for example. If during this process any quality defects are detected, corrective set-up measures will be carried out at the work station in question, and subsequently a new quality control will be carried out.

As soon as the quality of the tested letter envelope test samples meets the quality requirements, the drive of the letter envelope production machine is stopped, the reject deflector is moved into its production position, the collection container is removed from the extraction point, and the closing flap adhesive coating station is swung into its production position. Subsequently, the machine drive is activated again and the machine can be moved up to production speed.

In the case of this known method for the conversion of the letter envelope production machine from set-up mode to production mode, a disadvantage is the fact that due to the stopping of the machine drive occurring following the set-up, product or, respectively, letter envelope cutting displacements frequently occur in the letter envelope production machine whereby previously obtained set-up results can no longer be achieved following the restart of the machine for production operation so that the quality of the letter envelopes produced during the production operation will be inferior to the quality determined within the framework of the quality control during the set-up mode. In these cases, an undesired fresh set-up of the letter envelope production machine will be necessary together with the corresponding expenditures.

### SUMMARY OF THE INVENTION

One or more embodiments of the present invention provides a method for converting a letter envelope production machine from a set-up mode to a regular production mode that will assure that the quality of the letter envelope test samplings obtained in the set-up mode will also be obtained during the regular production operation without the necessity of carrying out the set-up mode multiple times.

In accordance with one or more embodiments of the invention, it is proposed to allow the letter envelope production machine to continue running at least at a base speed of greater than 0 m/s during the conversion from the set-up mode to the regular production mode so that the move of the work station from its extraction position to its production position occurs during the operation of the letter envelope production machine at this base speed. The set-up results obtained during the prior set-up mode can thereby be maintained for the regular production operation or, respectively, be carried over into the production operation without any loss of quality. Accordingly, only a one-time execution of the set-up mode will be required in a time, cost and resource-saving manner in order to take up the production operation under fulfillment of the preset quality requirements. In particular, the method in accordance with one or more embodiments of the invention will lead to a considerably lower generation of paper waste as compared with the state of the art.

In a manner that is known per se, a collection container to collect the extracted letter envelope test samples may be located at the extraction location in the set-up mode. According to one or more embodiments of the invention, the conversion of the letter envelope production machine from set-up mode to production mode also comprises, in addition to moving the work station into its production position, the removal of the collection container from the extraction point so that the removal of the collection container will also occur during the operation of the letter envelope production machine at base speed.

On the job safety of the operator of the letter envelope production machine is assured during the set-up mode by the fact that the collection container as well as, if necessary, other protective devices are designed in such a way that in the area of the extraction point the operator will not be able to come in contact with any movable parts of the letter envelope production machine. As an alternative to the collection container performing a safety function, it is conceivable to arrange in the area of the extraction point a safety-engineered barrier, for example in the form of a safety fence, in lieu of the collection container and to allow the extracted letter envelope test samples to drop to the ground.

During the set-up mode, the letter envelope production machine may be operated at a predetermined set-up speed that the operator can vary depending on the individual set-up requirements. In this case, the set-up speed may be moved up to the production speed of the regular production operation.

During the conversion in accordance with one or more embodiments of the invention of the letter envelope production machine from set-up mode into production mode, it will be run at a base speed of greater than 0 m/s, which is less than the regular production speed. This base speed is selected in such a way that the set-up results obtained during the prior set-up mode will be maintained completely or at least to the greatest extent for production operation. According to one or more embodiments of the invention, the base speed will be selected within a range from 5%-30% of the production speed. In most application cases, a base speed within the range from 10%-20% of the production speed has proved to be particularly advantageous.

According to one or more embodiments of the invention, for reasons of occupational safety, the run of the letter envelope production machine is stopped automatically if and when the conversion from set-up mode to production mode exceeds a predetermined time limit. In this context, the conversion process is automatically monitored by the machine control. To this end, for example, a safety-engineered barrier that is located at the extraction point and that actuates a safety switch or the like as long as it performs is securing function is monitored as to whether or not it is moved away from the extraction point and thus no longer performs its securing function. The point in time at which the safety-engineered barrier no longer performs its securing function is registered automatically by the machine control. If the machine control determines that the work station has not been moved into its production position within the predetermined time limit calculated from the registered point in time, it will immediately stop the drive of the letter envelope production machine. For reasons of occupational safety, the preset time limit after the expiration of which the drive will be stopped lies within a range of 10-50 s, for example at 20 s.

Alternatively, there is the possibility of not coupling the point in time at which the monitoring of the preset time limit begins with the deactivation of a safety-engineered barrier but with the activation of a separate safety button by the machine operator. In this variant, the point in time at which the machine operator activates the safety sensor will be automatically registered by the machine control. If and when the machine control determines that the work station has not been moved into its production position during the allotted time, it will immediately stop the drive of the letter envelope production machine. The safety-engineered barrier which prevents the operator from coming into contact with movable parts of the letter envelope production machine may be provided additionally in order to stop the drive of the letter envelope production machine immediately following its deactivation if the safety button was not activated by the operator beforehand.

The extraction point for the extraction of the letter envelope test samples for the execution of a quality control may be located at any arbitrary point of the letter envelope production machine as long as the corresponding work station can be moved back and forth at such a point in the required manner between an extraction position and a production position. Advantageously, the extraction point will be located where a multitude of the letter envelope production steps have already been carried out so that a corresponding number of production steps can be incorporated in the quality control. In this context it is particularly advantageous to extract the letter envelope test samples at an extraction point at which the letter envelope test samples are present in the form of incompletely finished letter envelope on which the letter envelope production steps of adhesive coating and of folding of the closing flap have not yet been performed. Since the aforementioned production steps are, as a rule, the final steps in the entire production process of a letter envelope, nearly finished letter envelopes will be present at this extraction point. In the case of this choice of the extraction point according to one or more embodiments of the invention, the work station movable between the extraction position and the production position is formed by the adhesive coating station for applying adhesive to the closing flap.

### BRIEF DESCRIPTION OF DRAWINGS

FIG. 1 shows an extraction point of a letter envelope production machine, with the adhesive coating station for applying adhesive to the closing flap being in its production position for regular production operation;

FIG. 2 shows the extraction point of the letter envelope production machine shown in FIG. 1, with the adhesive coating station for applying adhesive to the closing flap being in its extraction position for the start-up mode;

FIG. 3 shows a flow diagram to explain the method in accordance with one or more embodiments of the invention; and

FIG. 4 shows a schematic lateral view of a letter envelope production machine known from the state of the art.

### DETAILED DESCRIPTION

Exemplary embodiments of the invention will be described with reference to the accompanying figures. Like items in the figures are shown with the same reference numbers. In embodiments disclosed herein, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

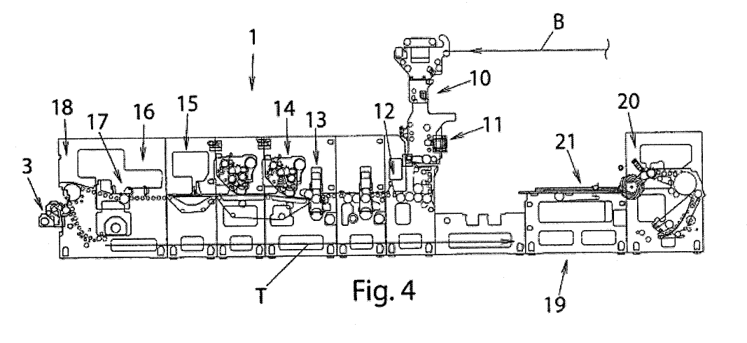

FIG. 4 shows in a schematic lateral view an example of a known letter envelope production machine 1 that produces letter envelopes in the form of letter wraps or shipping pouches from a paper web B fed to it. The unwinding station to unwind a paper supply roll as well as the printing station to imprint the paper web are not represented for the sake of simplicity. In the case of the actual machine, this station is located to the right of the machine components shown in FIG. 4.

The paper web B fed from the right in FIG. 4 is initially cut into precuts of letter envelopes at the contour cutting station 10 as well as at the separation cutting station 11.

At the pre-creasing station 12, pre-creasing scores are embedded in the precut letter envelopes in preparation of later creasing processes. At the window cutting station 13, the address window is cut out of the precut letter envelope. By means of the downstream window gluing station 14, a piece of window material is glued into the previously cut out address window. Subsequently, the lateral flaps of the precut letter envelopes are folded at the lateral flap folding station 15. The previously folded lateral flaps are coated with adhesive at the lateral flap adhesive coating station 16, and at the bottom flap folding station 17, the bottom flap is folded onto the adhesive coated lateral flaps.

The letter envelopes that are almost finished after passing through the bottom flap folding station 17 and that have non-adhesive coated and open or, respectively, not folded closing flaps are then gathered into a so-called scaling flow at the scaling station 18. This scaling flow is guided through the closing flap adhesive coating station 3 in which the exposed closing flaps are coated with adhesive. In FIG. 4, from left to right, the scale flow coated with adhesive in this manner is finally guided along the transport route T in the lower part of the machine frame to the drying station 19 where the closing flap adhesive is dried. After decollating the scale flow, the closing flaps coated with dried adhesive are folded at the closing flap folding station 20, and subsequently the finished letter envelopes are deposited on the stacking table 21.

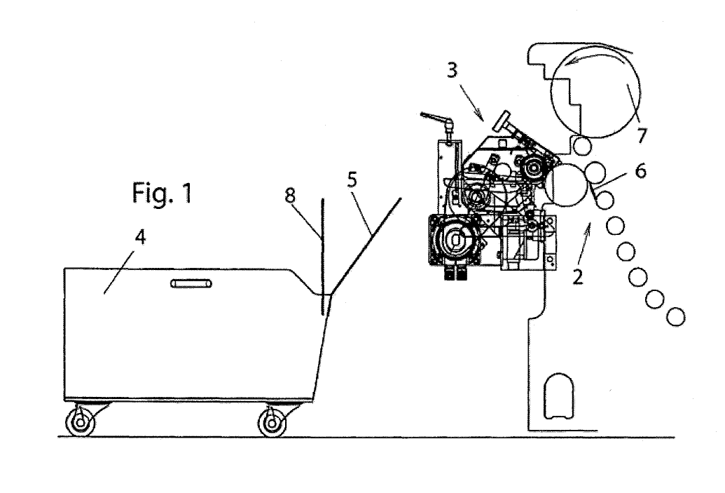

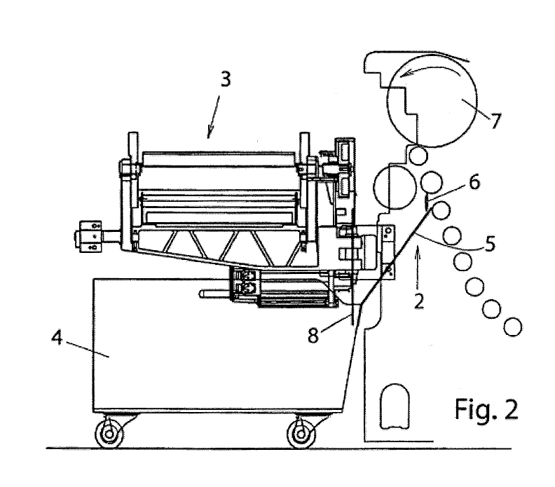

FIG. 1 shows the extreme left end of the letter envelope production machine 1 shown in FIG. 4. In the case of the one or more embodiments shown, an extraction point 2 for the extraction of letter envelope test samples as part of the set-up mode is located at this left end. At this extraction point 2, letter envelope test samples can be extracted in the form of almost finished letter envelopes on which the production steps of adhesive coating and folding of the closing flap have not yet been carried out. To this end, the closing flap adhesive coating station 3 can be moved from a production position shown in FIG. 1 into an extraction position shown in FIG. 2. In the case of the one or more embodiments shown, the movement of the closing flap adhesive coating station 3 between production position and extraction position occurs through a pivoting action around a vertical pivoting axis of at least 90°.

For the purpose of implementing the set-up mode, the closing flap adhesive coating station 3 is swung into its extraction position shown in FIG. 2. Furthermore, a movable collection container 4 corresponding to FIG. 2 in which the extracted letter envelope test samples are collected is moved close to the machine end or, respectively, to the extraction point 2. The collection container 4 is equipped with a safety cover 8, for example in the form of a protective grid shown here in vertical position, to prevent any contact with movable parts of the machine as well as a chute 5 attached at an angle. With the aid of a reject deflector 6 that is, for example, manually actuatable by a machine operator and that is moved from its production position shown in FIG. 1 into its extraction position shown in FIG. 2, the scaling flow adduced by the counterclockwise rotating cylinder 7 can be rerouted to the chute 5 and thus into the collection container 4.

The collection container 4 in its position shown in FIG. 2 together with its safety cover 8 forms a safety-engineered barrier that assures that the machine operator can not be injured by moving parts of the machine during the set-up mode. Moreover, the collection container 4 in its position shown in FIG. 2 actuates a safety switch (not shown) connected with the machine control and registers whether or not the collection container 4 is in its position shown in FIG. 2 or whether or not the safety-engineered barrier is present or, respectively, active.

As soon as the set-up mode of the letter envelope production machine 1 has been completed, i.e. as soon as the letter envelope test samples collected in the collection container 4 meet all quality requirements, the letter envelope production machine 1 can be converted to regular production operation. To this end, it is run at a base speed that is reduced relative to the production speed, and the reject deflector 6 is moved from its extraction position shown in FIG. 2 to its production position shown in FIG. 1.

Subsequently, the collection container 4 including its safety cover 8 and the chute 5 are removed from the extraction point 2. Then the closing flap adhesive coating station 3 is swung from its extraction position shown in FIG. 2 into its production position shown in FIG. 1 so that thereafter, the regular production operation at production speed can be started.

After moving the reject deflector 6 into its production position and before swinging the closing flap adhesive coating station 3 into its production position, letter envelopes are produced at base speed that have no adhesive or insufficient adhesive on their closing flaps. These letter envelopes can be extracted from the product flow by means of an additional reject deflector downstream in production direction of the closing flap adhesive coating station 3. Since the period of time between the move of the reject deflector 6 into its production position and the swinging of the closing flap adhesive coating station 3 into its production position is relatively short, consequently only a minor amount of such waste will be generated.

In the case of the one or more embodiments being discussed here, a safety button not shown in the drawings is arranged in the area of the extraction point 2. As soon as the safety button is actuated by the operator of the machine, it will be registered by the machine control. A preset time limit is stored in the machine control within which it is expected that the closing flap adhesive coating station 3 will reach its production position represented in FIG. 1. This is monitored with the aid of a suitable end switch that is likewise connected with the machine control. If the machine control detects that the closing flap adhesive coating station 3 does not reach its production position within the preset time limit calculated from the point in time of the actuation of the safety button, it will immediately turn off the drive of the letter envelope production machine 1 running at base speed.

As soon as the collection container 4 leaves its position shown in FIG. 2, the safety switch previously actuated by it will be released. If the operator did not actuate the separate safety button prior to the removal of the collection container 4, the drive of the letter envelope production machine 1 is stopped immediately for safety reasons in the case of the one or more embodiments at hand. Alternatively, there is the possibility of monitoring the expiration of the preset time limit for the conversion from the set-up mode into the production mode starting from the point in time the collection container 4 is moved and thus from the release of the safety switch. A separate safety switch to be actuated by the operator may be dispensed with this variant.

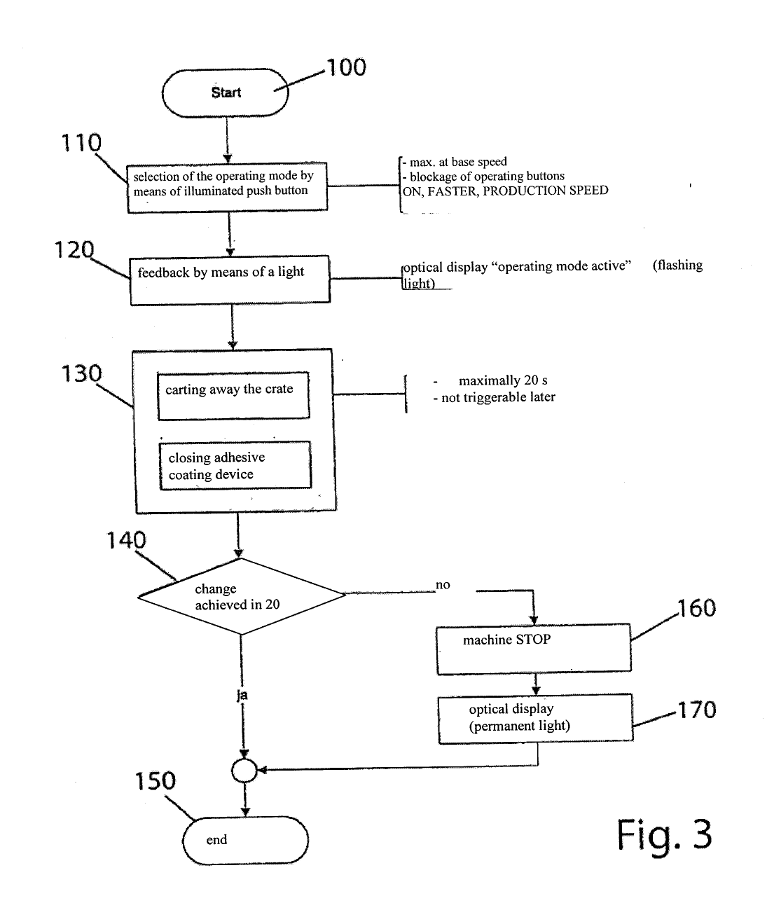

FIG. 3 shows a flow diagram that illustrates the course of the method in accordance with one or more embodiments of the invention. The program start occurs in step 100. According to step 110, the operating mode “conversion operation” for the conversion of the letter envelope production machine 1 from the set-up mode into the production mode is dialed in with the aid of a safety switch, for example in the form of an illuminated pushbutton. According to one or more embodiments of the invention, in this operating mode, operating the letter envelope production machine 1 is maximally possible at a base speed that is reduced relative to the production speed. All operating buttons that allow the operator to operate at a greater speed are blocked in this operating mode. In the subsequent step 120, a feedback of the dialed-in operating mode “conversion operation” occurs through an optical display, for example by means of a flashing light.

In step 130, a query is made whether or not the collection container 4 designed, for example, as a crate has been moved from its position shown in FIG. 2 and whether or not the closing flap adhesive coating station 3 has been closed or, respectively, moved into its production position. In the case of the described one or more embodiments, the machine operator has a preset time limit of maximally 20 s at his disposal for these two actions. This time limit is firmly preset in the machine control and can not be influenced by the machine operator.

In step 140, a query is made whether or not the removal of the collection container 4 and the closing of the closing flap adhesive coating station 3 has occurred within the preset time limit of 20 s. If both actions have occurred within the 20 s, the program will end in step 150. The machine speed can subsequently be increased to production speed.

If the two actions mentioned in step 130 did not occur within the 20 s, the machine drive will be stopped immediately in accordance with step 160 and the fact of the machine stop is reported to the operator in accordance with step 170 by means of an optical display, for example a continuous light. Subsequently, the programs will end here, too, in accordance with step 150.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### LIST OF REFERENCE NUMERALS

1 letter envelope production machine
2 extraction point
3 closing flap adhesive coating station
4 collection container
5 chute
6 reject deflector
7 cylinder
8 safety cover
10 contour cutting station
11 separation cutting station
12 pre-creasing station
13 window cutting station
14 window gluing station
15 lateral flap folding station
16 lateral flap adhesive coating station
17 bottom flap folding station
18 scaling station
19 drying station
20 closing flap folding station
21 stacking table
B paper web
T transport route

1. A method for converting a letter envelope production machine from a set-up mode to a production mode, comprising:
extracting during the set up mode letter envelope test samples from an extraction point of the letter envelope production machine for quality control, and
where said letter envelope production machine includes a work station in the area of the extraction point said work station configured to be movable that is movable between an extraction position in which letter envelope test samples are extracted and a production position in which letter envelopes are produced,
wherein the work station is in the extraction position during the set-up mode and the letter envelope test samples are extracted at the extraction point,
wherein the conversion of the letter envelope production machine from the set-up mode to the production mode including the movement of the work station to the production position,
wherein the letter envelope production machine continues running at least at a base speed during the conversion from the set-up mode to the production mode so that the movement of the work station to the production position during the operation of the letter envelope production machine will occur at the base speed and set-up results obtained during the prior set-up mode will essentially be maintained for the production mode.

2. The method of claim 1,
wherein, in the set-up mode, a collection container is located at the extraction point to collect the extracted letter envelope test samples, with the conversion of the letter envelope production machine from set-up mode to production mode also including removal of the collection container from the extraction point so that the removal of the collection container will also occur during the operation of the letter envelope production machine at the base speed.

3. The method of claim 1
wherein, in the production mode, the letter envelope production machine runs at a production speed, and
wherein the base speed is less than the production speed.

4. The method of claim 3,
wherein the base speed lies within a range of 5% to 30% of the production speed.

5. The method of claim 1,
wherein the letter envelope production machine will be stopped automatically when the conversion of the letter envelope production machine from set-up mode to production mode does not occur within a preset time limit, and
wherein the drive of the letter envelope production machine is stopped immediately when the work station does not reach the production position within the preset time limit, calculated from a time of deactivation of a safety-engineered barrier or of an actuation of a safety button by an operator.

6. The method of claim 5,
wherein the preset time limit lies within a range of 10 to 50 seconds.

7. The method of claim 1,
wherein the removal of the letter envelope test samples occurs at an extraction point at which letter envelope test samples are present in the form of not completely finished letter envelopes on which the letter envelope production steps of adhesive coating and folding of a closing flap have not yet been carried out, and
wherein the work station involves an adhesive coating station for the coating of the closing flap with an adhesive.

8. The method of claim 2,
wherein, in the production mode, the letter envelope production machine runs at a production speed, and
wherein the base speed is less than the production speed.

9. The method of claim 8, wherein the base speed lies within a range of 5% to 30% of the production speed.

10. The method of claim 2,
wherein the letter envelope production machine will be stopped automatically when the conversion of the letter envelope production machine from set-up mode to production mode does not occur within a preset time limit, and
wherein the drive of the letter envelope production machine is stopped immediately when the work station does not reach the production position within the preset time limit, calculated from a time of deactivation of a safety-engineered barrier or of an actuation of a safety button by an operator.

11. The method of claim 3,
wherein the letter envelope production machine will be stopped automatically when the conversion of the letter envelope production machine from set-up mode to production mode does not occur within a preset time limit, and
wherein the drive of the letter envelope production machine is stopped immediately when the work station does not reach the production position within the preset time limit, calculated from a time of deactivation of a safety-engineered barrier or of an actuation of a safety button by an operator.

12. The method of claim 4,
wherein the letter envelope production machine will be stopped automatically when the conversion of the letter envelope production machine from set-up mode to production mode does not occur within a preset time limit, and
wherein the drive of the letter envelope production machine is stopped immediately when the work station does not reach the production position within the preset time limit, calculated from a time of deactivation of a safety-engineered barrier or of an actuation of a safety button by an operator.

13. The method of claim 2,
wherein the removal of the letter envelope test samples occurs at an extraction point at which letter envelope test samples are present in the form of not completely finished letter envelopes on which the letter envelope production steps of adhesive coating and folding of a closing flap have not yet been carried out, and
wherein the work station involves an adhesive coating station for the coating of the closing flap with an adhesive.

14. The method of claim 3,
wherein the removal of the letter envelope test samples occurs at an extraction point at which letter envelope test samples are present in the form of not completely finished letter envelopes on which the letter envelope production steps of adhesive coating and folding of a closing flap have not yet been carried out, and
wherein the work station involves an adhesive coating station for the coating of the closing flap with an adhesive.

15. The method of claim 4,
wherein the removal of the letter envelope test samples occurs at an extraction point at which letter envelope test samples are present in the form of not completely finished letter envelopes on which the letter envelope production steps of adhesive coating and folding of a closing flap have not yet been carried out, and
wherein the work station involves an adhesive coating station for the coating of the closing flap with an adhesive.

16. The method of claim 5,
wherein the removal of the letter envelope test samples occurs at an extraction point at which letter envelope test samples are present in the form of not completely finished letter envelopes on which the letter envelope production steps of adhesive coating and folding of a closing flap have not yet been carried out, and
wherein the work station involves an adhesive coating station for the coating of the closing flap with an adhesive.

17. The method of claim 6,
wherein the removal of the letter envelope test samples occurs at an extraction point at which letter envelope test samples are present in the form of not completely finished letter envelopes on which the letter envelope production steps of adhesive coating and folding of a closing flap have not yet been carried out, and
wherein the work station involves an adhesive coating station for the coating of the closing flap with an adhesive.
